(19) United States
(12) Patent Application Publication
(10) Pub. No.: US 2026/0146664 A1
(43) Pub. Date: May 28, 2026

(54) METHOD FOR IDENTIFYING BELT SLIP IN A STARTING SYSTEM COMPRISING BISG

(71) Applicant: Ford Global Technologies, LLC, Dearborn, MI (US)

(72) Inventors: Ke Fan, Würselen (DE); Tobias Emig, Gelsenkirchen (DE)

(73) Assignee: Ford Global Technologies, LLC, Dearborn, MI (US)

(21) Appl. No.: 19/396,965

(22) Filed: Nov. 21, 2025

(30) Foreign Application Priority Data
Nov. 22, 2024 (DE) 10 2024 134 406.7

(51) Int. Cl. F16H 7/10; F16H 7/08

(52) U.S. Cl. CPC F16H 7/10; F16H 2007/0887

(57) ABSTRACT

A method for identifying belt slip in a starting system for starting an internal combustion engine of a motor vehicle. The starting system has a belt-driven integrated starter-generator (BISG) and an active tensioner that can actuate a belt between a position for low tension and a position for high tension. The method includes defining a first threshold value of the belt-driven integrated starter-generator, determining a torque value of the BISG, switching the active tensioner from the position for low tension to the position for high tension for a first predetermined period of time if the determined torque value is above the first threshold value, and reducing the first threshold value to a second threshold value for a second predetermined period of time following the first predetermined period of time.

### CROSS-REFERENCE TO RELATED APPLICATION

This application claims priority to and the benefit of German Patent Application No. 102024134406.7, filed on Nov. 22, 2024. The disclosure of the above application is incorporated herein by reference.

### FIELD

The present disclosure relates to a method for identifying belt slip in a starter system comprising a belt-driven integrated starter-generator (BISG).

### BACKGROUND

The statements in this section merely provide background information related to the present disclosure and may not constitute prior art.

WO 2011/047 992 A1 discloses a method for operating a belt drive of a motor vehicle, in which a high belt tension is set for a high load and a low belt tension is set in normal operation, wherein the setting of the respective belt tension is performed by a closed-loop control process taking into account the current load on the belt drive and/or taking into account the age of the belt of the belt drive. Furthermore, following the setting of the respective belt tension, it is checked whether a degree of belt slip is present and, if the presence of belt slip is identified, the belt tension is increased incrementally until the absence of belt slip is detected.

DE 10 2017 127 274 A1 discloses a variable belt tensioner for an engine, including a first damper and a second damper that is connected to the first damper via a drive device, wherein the first damper, the second damper and the drive device cause a belt connected to a crankshaft pulley and a starter-generator pulley to have a first tension when the engine comprising the crankshaft pulley starts. The first damper, the second damper and the drive device cause the belt to have a second tension that is less than the first tension when an electric current is generated by the starter-generator pulley, wherein the first damper, the second damper and the drive device cause the belt to have a second tension less than the first tension when an electric current is generated by the starter generator pulley, and wherein the first damper, the second damper and the drive device cause the belt to have a third tension that is less than the second tension when the vehicle is driven. The construction of this variable belt tensioner is very complex and disadvantageous with regard its NVH behavior during operation of the engine.

DE 10 2018 104 479 A1 describes methods and systems for identifying degradation of an active belt tensioner of an integrated starter/generator having belt drive (BISG), that is coupled to an internal combustion engine of a vehicle. By using the monitored change in FEAD load to compare the actual state of the tensioner (either retracted or extended state) relative to the commanded state, the presence of excess belt tension may be distinguished from the presence of insufficient belt tension. Timely diagnosis of a belt tensioner may enhance the condition of the belt and extend fuel efficiency benefits of a BISG system.

Particularly in P0 mild-hybrid systems, a belt-driven integrated starter-generator (BISG), which is connected to the front-end accessory drive (FEAD) of an internal combustion engine (ICE) via a belt, is used as a starter and generator. The BISG is used during operation of the internal combustion engine to recuperate energy and assist the internal combustion engine with the torque of the recuperated energy in order to reduce fuel consumption. On the one hand, the belt tension needs to be kept low in order to reduce parasitic friction loss. On the other hand, the belt tension needs to be high enough to ensure robust FEAD load transmission. An active two-stage tensioner (active tensioner), which can switch over between a low and a high belt tension, is therefore selected for setting the belt tension.

During operation of the internal combustion engine, the active tensioner remains in the low-tension position in order to minimize fuel consumption, and only switches over to the high-tension position when the requested BISG torque is above a particular threshold.

Belt slip can occur in the FEAD, having a detrimental effect on fuel efficiency, belt wear and the NVH (noise, vibration, harshness) behavior.

Belt slip occurs whenever the friction between the belt and the individual belt pulleys of the FEAD is not sufficient to transmit the required torque from one belt pulley to the other, i.e. in this case from the BISG to the crankshaft pulley of the internal combustion engine or vice versa. This may be caused by a faulty or incorrectly set belt tensioner, belt wear, elongation of the belt, soiling of the belt with liquids or materials that reduce the coefficient of friction between the belt surface and the surface of the belt pulley, and the like. These causes may be temporary, meaning for example that the belt slips when it is wet and, after the water has evaporated, it works as intended again, or they may be permanent, for example if the belt is worn, torn or the like.

The ideal configuration of the active tensioner when the internal combustion engine is running is to keep the belt tension as low as possible in order to reduce friction losses, but still high enough to transmit the wanted BISG torque without slip. The tendency and severity of belt slip increases as the BISG torque transmitted through FEAD increases.

In view of the above, with respect to the prior art cited there is still room for enhancement in the field of methods for identifying belt slip in a starting system comprising BISG.

### SUMMARY

This section provides a general summary of the disclosure and is not a comprehensive disclosure of its full scope or all of its features.

Further areas of applicability will become apparent from the description provided herein. It should be understood that the description and specific examples are intended for purposes of illustration only and are not intended to limit the scope of the present disclosure.

The disclosure is based on a method for identifying belt slip in a starting system comprising BISG. In particular, the belt slip identification and control when the internal combustion engine is running is provided in the present disclosure.

The present disclosure provides a method for identifying belt slip in a starting system for starting an internal combustion engine of a motor vehicle. The starting system having a belt-driven integrated starter-generator, and having an active tensioner that can actuate a belt between a position for low tension and a position for high tension. A threshold value for a slip of the belt is defined, above which the active tensioner switches from the position for low tension to the position for high tension for a continuous period of time. The threshold value for a slip of the belt being reduced for a period of time following this continuous period of time. This belt-slip threshold value is thus defined for the torque transmitted to the belt. If the torque is above the belt-slip threshold value, the active tensioner switches to the position for high tension. This threshold value for a slip of the belt is reduced if the belt slip is above the admissible threshold for a slip of the belt for an ascertained (predetermined) continuous (uninterrupted) time during operation with low tension. Advantageous developments are disclosed in the dependent claims.

It should be pointed out that the features and measures listed individually in the following description may be combined with each other in any technically expedient manner and reveal further developments of the disclosure. The description additionally characterizes and specifies the disclosure, in particular in conjunction with the figures.

The identification of the belt slip in the case of the events described at the beginning, and the triggering of countermeasures, is of decisive importance for protection against NVH developments and excessive wear, as well as for the provision of information to the driver and/or the establishing of a reliable state of the starting system.

According to the present disclosure, therefore, a threshold value is defined for a slip of the belt for high-tension operation. High-tension operation, which may also be referred to as a high-tension position, means in the context of the disclosure that the active tensioner is switched to the high-tension position. If the requested BISG torque is above the threshold value for a slip of the belt, the active tensioner switches to the high-tension position, otherwise to the low-tension position. In the context of the present disclosure, the low-tension position means that the active tensioner is switched to the low-tension position. The slip could be temporary, for example due to soiling of the belt. In this case, the belt may recover, i.e. it will function as intended again when the soiling disappears. In order to determine the switching point of the active tensioner in dependence on the slip tendency, the disclosure provides an adaptive method for controlling the belt tension on the basis of the identifying of slip during operation of the internal combustion engine. This adaptation has the effect that the threshold value for a slip of the belt is reduced for a period of time following this continuous period of time, such that the active tensioner of the starting system switches to the high-tension position earlier as a result.

In one configuration of the present disclosure, the threshold value for a slip of the belt is defined as the torque value of the belt-driven integrated starter-generator. The torque may be normally and reliably ascertained via sensors and/or indirectly from other parameters of the starting system. A standard switching point of the active tensioner is thus defined. The threshold value for a slip of the belt is defined as the BISG torque value at which the active tensioner switches from the low-tension position to the high-tension position. If the BISG torque demand is above this threshold value for a slip of the belt, the active tensioner switches to the high-tension position.

Furthermore, according to the present disclosure, an adaptive adjustment is effected by shifting the threshold value for a slip of the belt based on the sensed belt slip. If belt slip occurs during operation of the internal combustion engine, the rotational-speed difference between the BISG and the FEAD, in particular the crankshaft of the internal combustion engine, increases, and the rotational-speed difference may be used effectively and precisely for the adjustment.

In one configuration of the present disclosure, a relative rotational-speed difference between the rotational speeds of the BISG and the FEAD is calculated as a percentage and optionally compared with a predefinable, in particular a maximally admissible, rotational-speed difference threshold. The calculation of the relative rotational-speed difference is effected, for example, as follows:

$$RSD = \frac{{w}_{bisg} / tr - {w}_{crk}}{{w}_{bisg} / tr} \times 100 \%$$

RSD: relative rotational-speed difference
w_{bisg}: rotational speed of the belt-driven integrated starter=generator
w_{crk}: crankshaft rotational speed
tr: transmission rate

The transmission ratio “tr” is the transmission ratio between the crankshaft belt pulley and the BISG belt pulley. It is for example between 1 and 10, further for example between 2 and 5, and most preferably is 3 (+/−10%).

In a further configuration of the present disclosure, if during a BISG torque assistance event the BISG torque demand is below the current threshold value for a slip of the belt and the calculated relative rotational-speed difference is higher than the admissible rotational-speed difference threshold for a defined continuous period of time, a slip event is identified. This provides a reliable way of determining the slip of the belt.

In a further configuration of the disclosure, the threshold value for a slip of the belt for the active tensioner is reduced by a calibrated (predefinable) value following the identification of slip. This has the advantage that, in the next torque assistance, the active tensioner switches over to the high-tension position with a lower torque demand level in order to prevent further slip. This has an advantageous effect on the NVH behavior and is effective in reducing belt wear.

In a further configuration of the present disclosure, if the BISG torque demand is below the current threshold value for a slip of the belt and the calculated relative speed difference during torque assistance is below the admissible threshold value for a slip of the belt for a continuous period of time, it is assumed that the belt slip has recovered, i.e. it is operating as intended again, and the threshold value for a slip of the belt is reset by a calibrated (predefinable) value, in particular to a standard value.

In a further configuration of the present disclosure, the calibrated (predefined) values for raising and/or lowering the threshold value for a slip of the belt may be set such that a pronounced lowering of the threshold value for a slip of the belt is performed upon the detection of slip, and a gradual increase in the threshold for a slip of the belt is effected during recovery. The values depend on how desirable the belt slip is for the system. A desired approach is to reduce the threshold value for a slip of the belt by a large step of, for example, 5 Nm (Nm: Newton meters) when slip is identified, such that, for the next transmission, the active tensioner switches over to high tension at a lower torque level. When the slip has recovered again (reduced), the threshold value for a slip of the belt may be increased again in small steps of, for example, greater than 0 Nm up to approximately 2 Nm, to the original value.

In a further configuration, a determination of non-recoverable slip and countermeasures may be effected. Using the calculated adaptive threshold value for a slip of the belt, the active tensioner can switch to a high-tension position upon a request for lower BISG torque when belt slip occurs, and return directly or gradually to a predefined threshold value for a slip of the belt slip, preferably to a standard threshold value, when the belt slip is reduced. This may be the case, for example, if the belt is soiled with moisture such as, for example, water, and generates slip, but recovers after a while, i.e. it functions as intended again when the water evaporates. If the belt slip cannot be remedied due to belt ageing or a system fault, the threshold value for a slip of the belt drops to a critically low value. In this case, a control system may provide action information that requests, for example, a service check of the FEAD system, to either replace the belt or repair the belt.

For example, a normal, i.e. operational, system can transmit a torque of 15 Nm in the low-tension position. If slip is identified, the threshold value for a slip of the belt is reduced to approximately 10 Nm, which corresponds to the lower BISG torque transmission. If the threshold value for a slip of the belt drops further to greater than 0 Nm to 5 Nm, the desirable threshold value for a slip of the belt is reached. The aforementioned values are given as examples, and depend on the design of the system and its components.

In another form, the present disclosure provides a method for identifying belt slip in a starting system for starting an internal combustion engine of a motor vehicle. The starting system having a belt-driven integrated starter-generator (BISG) and having an active tensioner that can actuate a belt between a position for low tension and a position for high tension. The method comprising defining a first threshold value of the belt-driven integrated starter-generator, determining a first torque value of the BISG, switching the active tensioner from the position for low tension to the position for high tension for a first predetermined period of time if the determined first torque value is above the first threshold value, and updating the first threshold value to a second threshold value for a second predetermined period of time following the first predetermined period of time. The first threshold value is defined as a torque value of the belt-driven integrated starter-generator.

In one or more variations of the method of the above paragraph, which can be implemented individually or in any combination: the method further includes switching the active tensioner to the high-tension position upon a request for lower BISG torque when a belt slip occurs, and updating the first threshold value to a third threshold value when the belt slip is reduced; the method further includes calculating a relative rotational-speed difference (RSD) between a first rotational speed of the BISG and a second rotational speed of the starting system; the calculated relative rotational-speed difference (RSD) between a first rotational speed of the BISG and a second rotational speed of the starting system is compared with a predefinable rotational-speed difference threshold; the first threshold value is reduced by a predefinable value; the method further includes identifying a slip event, if during a BISG torque assistance event, a BISG torque demand is below the first threshold value and the calculated relative rotational-speed difference (RSD) is higher than the predefinable rotational-speed difference threshold for a defined period of time; the first threshold value is reduced by a predefinable value following the identification of slip; the method further includes resetting the first threshold value by a predefinable value if the BISG torque demand is below the first threshold value and the calculated relative speed difference (RSD) during torque assistance is below the predefinable rotational-speed difference threshold for a predefined period of time; and the method further includes outputting action information if the second threshold value is below a predetermined value.

The term “belt” used above also relates, of course, to other means for driving units that may be subject to slip (such as bands and the like) in relation to one another.

### DRAWINGS

In order that the disclosure may be well understood, there will now be described various forms thereof, given by way of example, reference being made to the accompanying drawings, in which:

Further advantageous developments of the disclosure are disclosed in the dependent claims and the following description of the figures, in which

FIG. 1 shows a schematic representation of a starting system according to the principles of the present disclosure; and

FIG. 2 shows a flow diagram for execution of the method according to the starting system according to the principles of the present disclosure.

In the different figures, parts that are the same are in each case denoted by the same reference designation, for which reason they are also described only once.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

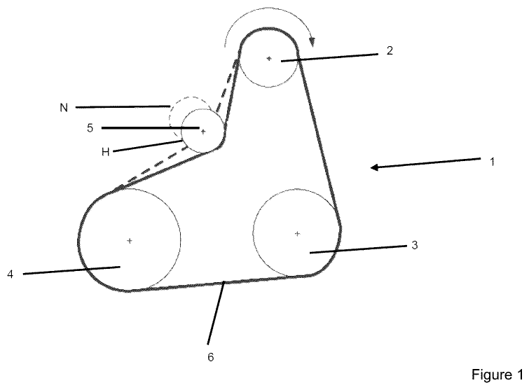

FIG. 1 shows a schematic representation of a starting system 1, also referred to as FEAD (front end accessory drive), in particular for a mild-hybrid system of a motor vehicle, the starting system 1 having a belt-driven integrated starter-generator 2 (belt-integrated starter generator-BISG). The latter is connected via a belt pulley 3 to an internal combustion engine by means a crankshaft belt pulley 4. The starting system 1 additionally has an active tensioner 5, and a belt 6 as a connection. In the following, the belt-driven integrated starter-generator 2 may also be referred to as BISG 2. The BISG 2 is also used during operation of the internal combustion engine in order to recuperate energy and assist the internal combustion engine with the torque from the recuperated energy. The active tensioner 5, which may, for example, change over between a position H with high belt tension and a position N with low belt tension, is provided for setting the belt tension.

During the starting phase of the combustion engine, during which the torque transmitted via the FEAD is very high, the active tensioner 5 is controlled so that it switches to the high-tension H position. While the combustion engine is running, the active tensioner 5 remains in the low-tension position N in order to reduce, fuel consumption, and it only switches over to the high-tension position if the demanded BISG torque is above a determined threshold value for a slip of the belt 6. The switching may be effected via a control unit (not represented) of the motor vehicle, which is also designed for execution of the method according to the disclosure for identifying belt slip in the starting system 1.

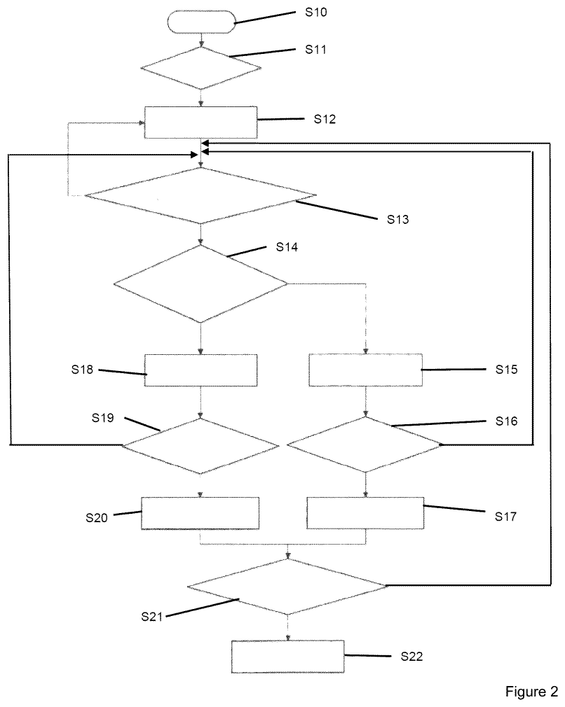

FIG. 2 shows a flow diagram for the execution of the method according to the present disclosure.

The method commences in S10 with “Start”.

In S11, it is queried whether the combustion engine is running. The function remains at S10 until the combustion engine starts up. The status of the running combustion engine may be confirmed, for example, by a status signal of the combustion engine, which in particular includes a plurality of statuses, such as standby, starting, running, stopping.

In S12, two mutually separate timers1 and timer2 are used to count the seconds in which the RSD value (RSD=rotation speed difference) is above and below a predefinable rotational-speed difference threshold. Due to the signal noise and transient behavior, the RSD values may have short-term peaks and dips. The timer1 and timer2 are therefore used to provide that only constant behaviors of the values is counted. They are reset to 0.

In S13, it is queried whether the condition 0<torque BISG<threshold value for a slip of the belt 6 is fulfilled. Timer1 and timer2 are used here to count the seconds in which an RSD value (RSD=rotation speed difference, see also the following description relating to step S14) is above and below a predefinable rotational-speed difference threshold, in particular a maximally admissible rotational-speed difference threshold, for the identification of slip during torque transmission at low tension. If the BISG torque is above the threshold for a slip of the belt 6, it is assumed that the torque is transmitted in the high-tension position. Timer1 and timer2 are reset to 0 and only start counting again when the next torque is transmitted at low tension, with the torque BISG having been sensed beforehand. Sensing is effected, for example, via the feedback from the BISG machine. The BISG machine provides the current BISG rotational speed and the torque. Alternatively, the sensing may also be determined indirectly. In the case of electric machines, for example, the torque may be estimated from the voltage, current, rotational speed and efficiency, and thus determined indirectly.

In S14, it is queried whether the aforementioned rotational-speed difference, i.e. the RSD value (RSD=rotation speed difference), between the BISG and a crankshaft (FEAD) is below the predefinable rotational-speed difference threshold. The rotational-speed difference threshold in this case is the percentage rotational-speed difference between the crankshaft belt pulley and the BISG belt pulley. It may be ascertained by bench tests in which the slip value of systems with normal (no slip) and slipping belts has been compared. The percentage rotational-speed difference threshold may be selected between in particular 1% and 10%, further in particular between 3% and 7%, and further in particular around 4% (+/−10%). If this is the case, in S15 the timer1 is reset, in particular reset to 0. The flow diagram is repeated for each calculation step of the electronic computing unit by which the method is performed. Timer1 and timer2 count the actual time. The program returns to S13 and continues to check the BISG torque and the RSD value, and increments timer1 and timer2 with the calculation time step by a predefined time in each case, preferably selected between 10 milliseconds (ms) and 100 milliseconds (+/−10%). For example, an increment is effected every 10 ms or 100 ms.

In S16, it is queried whether the timer2 is above a predefinable timer2 threshold. Timer2 is used here to count the seconds in which the RSD value is below the rotational-speed difference threshold for the identification of slip during torque transmission at low tension. If the BISG torque is above the threshold for a slip of the belt 6, it is assumed that the torque is transmitted in the high-tension position. If the time counted by the timer2 is above the timer2 threshold, the threshold value for a slip of the belt 6 is reduced in S17 by a calibrated (predefinable) value TrqThld_Decr. As explained further above, this value is, for example, 5 Nm. This is followed by step S21. If the timer2 has not exceeded its timer2 threshold, the process jumps back to the input point of step S13.

If it was established in S14 that the rotational-speed difference RSD is below an admissible rotational-speed difference threshold, timer2 is reset to 0 in S18 (as for the procedure for timer1) and timer1 is incremented. Here too, the flow diagram is repeated for each calculation step of the electronic computing unit by which the method is performed.

In S19, as in S16 (see the description there), it is queried whether the timer1 is above a predefinable timer1 threshold. If this is the case, in S20 the threshold value for a slip of the belt 6 is increased by a calibrated (predefinable) value TrqThld_Incr, for example by the 2 Nm mentioned further above. This is followed by step S21. If timer1 is still below the threshold, the process jumps back to the input point of S13.

Finally, in S21 it is queried whether the threshold value for a slip of the belt 6 is below a predefinable desirable value. The desirable value is, for example, the lowest torque that a belt should still transmit reliably while maintaining its function with low tension, such as, for example, 5 Nm. If this is the case, action information is given, for example a check is requested in S22. If the threshold value for a slip of the belt 6 in S21 is not below the desirable value, here too the process jumps back to the input point of S13, and the processes described above are performed again and, if necessary, repeatedly by the electronic computing unit of the control system of the internal combustion engine.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for identifying belt slip in a starting system for starting an internal combustion engine of a motor vehicle, the starting system having a belt-driven integrated starter-generator (BISG), and having an active tensioner that can actuate a belt between a position for low tension and a position for high tension, the method comprising:
defining a first threshold value of the belt-driven integrated starter-generator;
determining a first torque value of the BISG;
switching the active tensioner from the position for low tension to the position for high tension for a first predetermined period of time if the determined first torque value is above the first threshold value; and
reducing the first threshold value to a second threshold value for a second predetermined period of time following the first predetermined period of time.

2. The method according to claim 1, wherein the first threshold value is defined as a torque value of the belt-driven integrated starter-generator.

3. The method according to claim 1, further comprising calculating a relative rotational-speed difference (RSD) between a first rotational speed of the BISG and a second rotational speed of the starting system.

4. The method according to claim 3, wherein the calculation is according to the following formula:
$$RSD = \frac{{w}_{bisg} / tr - {w}_{crk}}{{w}_{bisg} / tr} \times 100 \% .$$

5. The method according to claim 3, wherein the calculated relative rotational-speed difference (RSD) between a first rotational speed of the BISG and a second rotational speed of the starting system is compared with a predefinable rotational-speed difference threshold.

6. The method according to claim 3, wherein the first threshold value is reduced by a predefinable value.

7. The method according to claim 3, further comprising identifying a slip event, if during a BISG torque assistance event, a BISG torque demand is below the first threshold value and the calculated relative rotational-speed difference (RSD) is higher than a predefinable rotational-speed difference threshold for a defined period of time.

8. The method according to claim 7, wherein the first threshold value is reduced by a predefinable value following the identification of the slip event.

9. The method according to claim 7, further comprising resetting the first threshold value by a predefinable value if the BISG torque demand is below the first threshold value and the calculated relative speed difference (RSD) during torque assistance is below the predefinable rotational-speed difference threshold for a predefined period of time.

10. The method according to claim 3, further comprising switching the active tensioner to the position for high tension upon a request for lower BISG torque when a belt slip occurs, and updating the first threshold value to a third threshold value when the belt slip is reduced.

11. The method according to claim 1, further comprising outputting action information if the second threshold value is below a predetermined value.

12. A method for identifying belt slip in a starting system for starting an internal combustion engine of a motor vehicle, the starting system having a belt-driven integrated starter-generator (BISG), and having an active tensioner that can actuate a belt between a position for low tension and a position for high tension, the method comprising:
defining a first threshold value of the belt-driven integrated starter-generator, the first threshold value is defined as a torque value of the belt-driven integrated starter-generator;
determining a first torque value of the BISG;
switching the active tensioner from the position for low tension to the position for high tension for a first predetermined period of time if the determined first torque value is above the first threshold value; and
updating the first threshold value to a second threshold value for a second predetermined period of time following the first predetermined period of time.

13. The method according to claim 12, further comprising switching the active tensioner to the position for high tension upon a request for lower BISG torque when a belt slip occurs, and updating the first threshold value to a third threshold value when the belt slip is reduced.

14. The method according to claim 12, further comprising calculating a relative rotational-speed difference (RSD) between a first rotational speed of the BISG and a second rotational speed of the starting system.

15. The method according to claim 14, wherein the calculation is according to the following formula:
$$RSD = \frac{{w}_{bisg} / tr - {w}_{crk}}{{w}_{bisg} / tr} \times 100 \% .$$

16. The method according to claim 14, wherein the calculated relative rotational-speed difference (RSD) between a first rotational speed of the BISG and a second rotational speed of the starting system is compared with a predefinable rotational-speed difference threshold.

17. The method according to claim 14, wherein the first threshold value is reduced by a predefinable value.

18. The method according to claim 13, further comprising identifying a slip event, if during a BISG torque assistance event, a BISG torque demand is below the first threshold value and the calculated relative rotational-speed difference (RSD) is higher than a predefinable rotational-speed difference threshold for a defined period of time.

19. The method according to claim 18, wherein the first threshold value is reduced by a predefinable value following the identification of the slip event.

20. The method according to claim 18, further comprising resetting the first threshold value by a predefinable value if the BISG torque demand is below the first threshold value and the calculated relative speed difference (RSD) during torque assistance is below the predefinable rotational-speed difference threshold for a predefined period of time.
